(19) United States
(12) Patent Application Publication
(10) Pub. No.: US 2014/0279519 A1
(43) Pub. Date: Sep. 18, 2014

(54) METHOD AND SYSTEM FOR OBTAINING AND USING IDENTIFICATION INFORMATION

(71) Applicant: JUMIO INC., Palo Alto, CA (US)

(72) Inventors: Daniel Herbert MATTES, Wels (AT); Thomas WILLOMITZER, Vienna (AT); Marc BARACH, Oakland, CA (US)

(73) Assignee: JUMIO INC., Palo Alto, CA (US)

(21) Appl. No.: 13/837,599

(22) Filed: Mar. 15, 2013

(51) Int. Cl. G06Q 20/40; G06K 9/00; G06Q 20/38

(52) U.S. Cl. CPC G06Q 20/4014; G06Q 20/3821; G06K 9/00442
USPC 705/44

(57) ABSTRACT

A method of identifying a user for transactions includes receiving an image of an identification document of the user during a first transaction with a first party, wherein the image is obtained using an image acquisition module of a device of the user, receiving a device ID of the user's device, extracting identification credentials of the user from the image, storing the identification credentials of the user and the device ID of the user's device on a server, wherein the device ID is associated with the identification credentials of the user, during a subsequent transaction with a second party, receiving the device ID of the user's device, retrieving the identification credentials of the user based on the device ID, and transmitting the retrieved identification credentials to the second party to identify the user for the subsequent transaction.

### FIELD

This disclosed subject matter relates generally to the field of identification and/or payment systems and methods, and more particularly to obtaining and using identification information.

### BACKGROUND

User identification and verification is important for many transactions with merchants and service providers. This is especially true with online transactions for large amounts of money when users and merchants or service providers are remote from each other. Traditionally, a user needs to present her identification document and verify herself with an online merchant or service provider for some transactions. The conventional mechanisms of identifying and verifying users are inconvenient and inefficient, and result in burdens for users.

### SUMMARY

In accordance with the disclosed subject matter, systems and methods are described for obtaining and using identification information.

The disclosed subject matter includes, in one aspect, a computerized method of identifying a user for transactions, which includes receiving an image of an identification document of the user during a first transaction with a first party, wherein the image is obtained using an image acquisition module of a device of the user. This method also includes receiving a device ID of the user's device and extracting identification credentials of the user from the image, as well as storing the identification credentials of the user and the device ID of the user's device on a server. The device ID can be associated with the identification credentials of the user. During a subsequent transaction with a second party, the method can include receiving the device ID of the user's device, retrieving the identification credentials of the user stored on the server based on the device ID received during the subsequent transaction, and transmitting the retrieved identification credentials to the second party to identify the user for the subsequent transaction. In some embodiments, the identification document is selected from a group consisting of an identification card, a driver's license, a passport, and a utility bill.

In some other embodiments, the computerized method of identifying a user for transactions also includes authenticating the identification credentials of the user with an authentication authority during the first transaction.

In another embodiment, the disclosed subject matter includes a computer system for identifying a user for transactions. In this embodiment, the subject matter includes a client interface configured to, during a first transaction, receive an image of an identification document of a user from a device of the user and to receive a device ID of the user's device. This embodiment can also include an identification credential extractor configured to extract identification credentials of the user from the image, and an identification credential manager configured to, during the first transaction, store both the identification credentials of the user and the device ID, wherein the device ID is associated with the identification credentials of the user. This embodiment can also include a third-party interface configured to, during the first transaction, transmit the identification credentials to a third party to identify the user. The client interface can further be configured to, during a subsequent transaction, receive the device ID, and the identification credential manager can be further configured to, during the subsequent transaction, retrieve the identification credentials of the user based on the received device ID, wherein the third-party interface is further configured to, during the subsequent transaction, transmit the retrieved identification credentials to identify the user.

In some embodiments, the computer system for identifying a user for transactions also includes an authentication authority interface configured to transmit the identification credentials of the user to an authentication server to authenticate the identification credentials of the user during the first transaction.

In still other embodiments, the disclosed subject matter includes a computerized method of identifying a user for transactions, which includes receiving identification credentials of the user during a first transaction with a first party, wherein the identification credentials are obtained using a device of the user. This method can also include receiving a device ID of the user's device, storing the identification credentials of the user and the device ID of the user's device on a server, wherein the device ID is associated with the identification credentials of the user. During a subsequent transaction with a second party, the method can include receiving the device ID of the user's device, retrieving the identification credentials of the user stored on the server based on the device ID received during the subsequent transaction, and transmitting the retrieved identification credentials to the second party to identify the user for the subsequent transaction.

The disclosed subject matter includes, in yet another aspect, a computer system for identifying a user for transactions, which includes a client interface configured to, during a first transaction with a first party, receive identification credentials of a user from a device of the user and to receive a device ID of the user's device, an identification credential manager configured to, during the first transaction, store both the identification credentials of the user and the device ID, wherein the device ID is associated with the identification credentials of the user, and a third-party interface configured to, during the first transaction, transmit the identification credentials to a third party to identify the user, wherein the client interface is further configured to, during a subsequent transaction with a second party, receive the device ID, and the identification credential manager is further configured to, during the subsequent transaction, retrieve the identification credentials of the user based on the received device ID, wherein the third-party interface is further configured to, during the subsequent transaction, transmit the retrieved identification credentials to identify the user.

The disclosed subject matter includes, in yet another aspect, a computerized method of identifying a user for transactions, which includes during a first transaction with a first party, acquiring an image of an identification document of the user from an image acquisition module of a device of the user, determining a device ID of the user's device, transmitting the image of the identification document of the user along with the device ID to a server to identify the user for the first transaction, during a subsequent transaction with a second party, transmitting the device ID to the server to identify the user for the subsequent transaction, and receiving confirmation of identification of the user based on the transmitted device ID during the subsequent transaction with the second party.

Various embodiments of the subject matter disclosed herein can provide one or more of the following capabilities. An identification credential system can provide more convenient and efficient mechanisms for obtaining and using identification information. An identification credential system can ease the burden of users and can also improve efficiency and lower cost for online merchants or service providers. Easier and quicker transactions may encourage users to engage in more online transactions—enhancing business of online merchants or service providers.

These and other capabilities of embodiments of the disclosed subject matter will be more fully understood after a review of the following figures, detailed description, and claims.

### BRIEF DESCRIPTION OF THE DRAWINGS

The disclosed subject matter is illustrated in the figures of the accompanying drawings which are meant to be exemplary and not limiting, in which like references are intended to refer to like or corresponding part, and in which:

FIG. 1 illustrates an exemplary identification credential system environment according to certain embodiments of the disclosed subject matter;

FIG. 2 is a block diagram of an exemplary identification credential server according to certain embodiments of the disclosed subject matter;

FIG. 3 is an exemplary identification credential directory (ICD) according to certain embodiments of the disclosed subject matter;

FIG. 4 is a block diagram of an exemplary identification credential agent according to certain embodiments of the disclosed subject matter;

FIG. 5 is an exemplary operation of obtaining and using identification credentials according to certain embodiments of the disclosed subject matter;

FIG. 6 is another exemplary operation of obtaining and using identification credentials according to certain embodiments of the disclosed subject matter;

FIG. 7 is an exemplary user interface for obtaining and using identification credentials according to certain embodiments of the disclosed subject matter; and

FIG. 8 is a block diagram of an exemplary computing system according to certain embodiments of the disclosed subject matter.

### DETAILED DESCRIPTION

In the following description, numerous specific details are set forth regarding the systems and methods of the disclosed subject matter and the environment in which such systems and methods may operate, in order to provide a thorough understanding of the disclosed subject matter. It will be apparent to one skilled in the art, however, that the disclosed subject matter may be practiced without such specific details, and that certain features, which are well known in the art, are not described in detail in order to avoid complication of the disclosed subject matter. In addition, it will be understood that the embodiments described below are only examples, and that it is contemplated that there are other systems and methods that are within the scope of the disclosed subject matter. Numerous changes in the details of implementation of the disclosed subject matter can be made without departing from the spirit and scope of the disclosed subject matter. Features of the disclosed embodiments can be combined and rearranged in various ways.

An identification credential system, according to certain embodiments of the disclosed subject matter, can provide more convenient and efficient mechanisms for obtaining and using identification information. An identification credential system can ease the burden of users. For example, a user of the identification credential system may only need to present her identification document or credentials during a first transaction; the user may not need to present her identification document or credentials again during a subsequent transaction, even if the subsequent transaction is directed to a new merchant or service provider. Some transactions require verification of identification. As examples, large online purchases may require verification of identification, as may opening a bank account or an online gambling account. An identification credential system can also improve efficiency and lower cost for online merchants or service providers. For example, an online merchant or service provider may reduce or eliminate the need of maintaining its own user identification and verification system. Easier and quicker transactions may encourage users to engage more online transactions—enhancing business of online merchants or service providers. The system can also allow merchants to obtain KYC (Know Your Customer) information easily without bother to the customer.

Embodiments of the disclosed subject matter can be implemented in a networked computing environment. FIG. 1 illustrates an exemplary identification credential system environment 100 in accordance with an embodiment of the disclosed subject matter. The system environment 100 can include one or more identification credential clients 110, an identification credential server 140, a storage medium 150 associated with the server 140, an authentication authority 160, a third party 170, a cloud storage 180, and a third party token provider (TPTP) 190, which can all be coupled, directly or indirectly, to a network 130 via wired and/or wireless connection.

Each identification credential client 110 can communicate with the identification credential server 140 to send data to, and receive data from, the identification credential server 140, e.g., across the network 130. Each identification credential client 110 can be directly coupled to the identification credential server 140; alternatively, each identification credential client 110 can be connected to the identification credential server 140 via any other suitable device, communication network, or combination thereof. For example, each identification credential client 110 can be coupled to the identification credential server 140 via one or more routers, switches, access points, and/or communication network (as described below in connection with the network 130). Each identification credential client 110 can be in the form of, for example, a desktop computer, a mobile computer, a tablet computer, a cellular device, a smartphone, or any computing systems that are capable of performing computation.

Each identification credential client 110 can include an image acquisition module 115 and an identification credential agent 120. The image acquisition module 115 can capture an image of an identification document of a user. The identification credential client 110 can optionally process the captured image and then send the relevant information to the identification credential server 140 for further processing. As an example, the image acquisition module 115 can be the camera in an embodiment in which the identification credential client 110 is a smartphone.

The identification credential agent 120 of the client 110 can help support a service of obtaining and using identification credentials. The identification credential agent 120 can be embedded inside the identification credential client 110 as a software module, a hardware component, or a combination of both. Alternatively, the identification credential agent 120 can be separate from but coupled to the identification credential client 110. The identification credential client 110 can communicate with the identification credential server 140 directly or via its agent 120. The structures, functions, and features of the identification credential agent 120 are described in detail later in this document.

The network 130 can include the Internet, a cellular network, a telephone network, a computer network, a packet switching network, a line switching network, a local area network (LAN), a wide area network (WAN), a global area network, or any number of private networks currently referred to as an Intranet, and/or any other network or combination of networks that can accommodate data communication. Such networks may be implemented with any number of hardware and software components, transmission media and network protocols. Although FIG. 1 illustrates the network 130 as a single network, the network 130 can include multiple interconnected networks listed above.

The identification credential server 140 can include an internal storage medium and can also be coupled to an external storage medium (e.g., the storage medium 150), which can be configured to store data for the identification credential server 140. Any identification credential client 110 can also store data in, and access data from, the storage medium 150 via the identification credential server 140. Although FIG. 1 shows the identification credential server 140 and the storage medium 150 as separate components, the identification credential server 140 and the storage medium 150 can be combined together. In addition, although FIG. 1 shows the identification credential server 140 as a single server, the identification credential server 140 can include more than one physical and/or logical servers. Moreover, although FIG. 1 shows the storage medium 150 as a single storage medium, the storage medium 150 can include more than one physical and/or logical storage medium. The storage medium 150 can be located in the same physical location as the identification credential server 140, at a remote location, or any other suitable location or combination of locations. Each identification credential server 140 can be in the form of, for example, a desktop computer, a mobile computer, a tablet computer, a cellular device, a smartphone, or any computing systems that are capable of performing computation.

The authentication authority 160 can provide authentication service to the identification credential client 110, the identification credential server 140, or other components of the system environment 100. The authentication authority 160 can be operated by, controlled by, or associated with the same entity that operates, controls, or is associated with the identification credential server 140; alternatively, the authentication authority 160 can be operated by, controlled by, or associated with a different entity, which may or may not be related. Although FIG. 1 shows the authentication authority 160 as a single server, the authentication authority 160 can include more than one physical and/or logical servers.

The third party 170 can provide other relevant services to the identification credential client 110, the identification credential server 140, or other components of the system environment 100. The third party 170 can be an online merchant or retailer from which users of the system environment 100 can purchase products. For example, the third party 170 can be a retailer e-commerce web service (e.g., BestBuy.com, etc.) which may need to verify a user's identification credentials (e.g., name and address). The third party 170 can also be a service provider which can provide a service to users of the system environment 100. For example, the third party 170 can be an online entertainment provider (e.g., gambling server) which may need to verify a user's identification credentials (e.g., age and nationality) for the opening of an account. The third party 170 can also be a service provider such as a bank, which may need to verify a user's identification credentials (e.g., age, current address, and nationality) for the opening of an account. The third party 170 can be operated by, controlled by, or associated with the same entity that operates, controls, or is associated with the identification credential server 140 and/or the authentication authority 160; alternatively, the third party 170 can be operated by, controlled by, or associated with a different entity, which may or may not be related. Although FIG. 1 shows the third party 170 as a single server, the third party 170 can include more than one physical and/or logical servers. In addition, although FIG. 1 shows only a single third party 170, numerous third parties can be used within the scope of the invention.

The cloud storage 180 can store data from the storage medium 150 with the same restrictions, security measures, authentication measures, policies, and other features associated with the storage medium 150. FIG. 1 shows the cloud storage 180 separate from the network 130; however, the cloud storage 180 can be part of the network 130 or another network. The identification credential server 140 can use only the storage medium 150, only the cloud storage 180, or both. While FIG. 1 shows only one cloud storage 180, more than one cloud storage or any suitable combination thereof can be used.

The third party token provider (TPTP) 190 can provide tokens for the identification credential system environment 100. The TPTP 190 can be operated by, controlled by, or associated with the same entity that operates, controls, or is associated with the identification credential server 140, the authentication authority 160, and/or the third party 170; alternatively, the TPTP 190 can be operated by, controlled by, or associated with a different entity, which may or may not be related. Although FIG. 1 shows the TPTP 190 as a single server, the TPTP 190 can include more than one physical and/or logical servers. In addition, although FIG. 1 shows only one TPTP 190, numerous TPTPs can be used within the scope of the invention. TPTP 190 will be discussed in more details later.

An identification credential server can provide features and functionalities to an identification credential system environment (e.g., 100 in FIG. 1). An exemplary identification credential server 140 according to certain embodiments of the disclosed subject matter is illustrated in FIG. 2. The identification credential server 140 can include an identification credential agent interface 210, an identification credential extractor 220, an identification credential manager 230, an authentication authority interface 240, a third-party interface 250, and a third party token provider (TPTP) interface 260. An identification credential server 140 can have some or all of these components; in addition, an identification credential server 140 can have additional components.

The identification credential server 140 can communicate with one or more identification credential agent/clients 110 through the identification credential agent interface 210. The identification credential server 140 can receive an image of an identification document or identification credentials of a user from an identification credential client (e.g., 110 in FIG. 1) via the identification credential agent interface 210. An identification document can be any identification card, a driver's license, a passport, a utility bill, or any other document containing identification information. In addition, the identification credential server 140 can also request additional information (e.g., a new image of the identification document, an image of a new identification document, new identification credentials) from an identification credential client (e.g., 110 in FIG. 1). Furthermore, the identification credential server 140 can also receive other information (e.g., a device ID, etc.) from an identification credential client (e.g., 110 in FIG. 1). Device ID is discussed in detail in later sections of this document.

The identification credential extractor 220 can extract identification credentials, e.g., from an image of an identification document. In some embodiments, the identification credential extractor 220 can recognize the textual information (e.g., via optical character recognition or OCR techniques) on an image. For example, the identification credential extractor 220 can extract identification credentials (e.g., name, gender, age, and address, etc.) from an image of a user's driver license. If the identification credential extractor 220 is unable to extract sufficient identification credentials, the identification credential extractor 220 can inform the identification credential client/agent 110 and/or request a new image of the identification document or an image of a new identification document, e.g., via the identification credential agent interface 210.

The identification credential manager 230 can manage identification credentials of users of an identification credential system environment (e.g., 100 in FIG. 1). In some embodiments, the identification credential manager 230 can store the identification credentials along with the device ID of the device from which the identification credentials originated. For example, the identification credential manager 230 can maintain an identification credential directory (ICD) storing identification credentials and their associated device IDs.

FIG. 3 illustrates an exemplary ICD 300 according to certain embodiments of the disclosed subject matter. The ICD 300 can include identification credential information, user ID information, and device ID information, as well as other relevant information (e.g., whether certain identification credentials have been authenticated). One user can use one or more devices (e.g., a laptop computer and a smartphone) and can have one or more identification documents (e.g., a passport and a driver's license). Assuming each user is unique, one set of identification credentials (e.g., identification credentials-1) can preferably be derived from the multiple identification documents of the user, e.g., automatically. In ICD 300, each set of identification credentials can be associated with a user ID and one or more device IDs. For example, in the ICD 300, identification credentials-1 is associated with user ID “A” and device ID “1,” while identification credentials-3 is associated with user ID “C” and device IDs “3” and“4.” The ICD 300 can reside on the identification credential server 140 itself or on other resources (e.g., the storage medium 150 or the cloud storage 180, etc.). The identification credential manager 230 can add new identification credentials into the ICD 300, update/delete existing identification credentials in the ICD 300, or retrieve identification credentials based on an device ID. The identification credential manager 230 can also manage or keep track of a user's identification documents in addition to the identification credentials extracted therefrom. For example, the identification credential manager 230 can add a new identification document when it is received the first time, can remove/lock an identification document if, e.g., it has expired, or can remove/lock all identification documents of a user if, e.g., one of the user's devices is reported lost/stolen. In some embodiments, the identification credential manager 230 can generate a new user ID when the new user's identification credentials are received at the identification credential server 140 the first time.

Referring again to FIG. 2, the identification credential server 140 can communicate with one or more authentication authority 160 through the authentication authority interface 240 to authenticate identification credentials. For example, an identification credential server can communicate with a governmental authority (e.g., Department of Motor Vehicles) via the authentication authority interface 240 to authenticate identification credentials extracted from an image of a driver's license. In another example, an identification credential server can communicate with a passport issuing agency via the authentication authority interface 240 to authenticate identification credentials extracted from an image of a passport. Authentication statuses can be stored in an identification credential directory (e.g., 300 in FIG. 3).

The identification credential server 140 can communicate with one or more third party (e.g., 170 in FIG. 1) through the third-party interface 250, which can receive identification credentials. In some embodiments, the identification credential server 140 can transmit identification credentials to the third party 170 to identify a user for certain transactions. For example, an identification credential server 140 can send payment information (e.g., credit card information) or identification information (e.g., name and address and/or additional information) to a retailer's e-commerce system to facilitate a purchase and shipping transaction. In another example, an identification credential server 140 can send identification credentials (e.g., age and nationality and/or additional information) to an online gambling system to verify a user's eligibility.

The identification credential server 140 can communicate with one or more third party token providers (TPTP) (e.g., 190 in FIG. 1) through the TPTP interface 260, which can receive third party tokens. One example of a TPTP is a social networking website; one example of a third party token is a social networking website userID. In one example, a third party 170 (e.g., a merchant) can send the identification credential server 140 the social networking website userID (or an encrypted/hashed version thereof) of the user (the merchant's customer). The identification credential server 140 can store the social networking website userID along with the identification credentials of the user. Later, in a subsequent transaction, when the same or different third party 170 sends the identification credential server 140 the social networking website userID of the user, the identification credential server 140 can look up the user's credentials using the social networking website userID.

One or more identification credential clients can participate in an identification credential system environment (e.g., 100 in FIG. 1). An identification credential client (e.g., 110 in FIG. 1) can include an identification credential agent. An exemplary identification credential agent 120 according to certain embodiments of the disclosed subject matter is illustrated in FIG. 4. The identification credential agent 120 can include a user interface 410, a host interface 420, an identification credential extractor 430, a device ID determiner 440, and a communication module 450. An identification credential agent 120 can have some or all of these components.

The identification credential agent 120 can communicate with users through the user interface 410. A user can input an image of an identification document or identification credentials to the identification credential agent 120 through the user interface 410. In one example, if the user already has an image of her identification document (e.g., passport), the user may not need to capture an image of her passport. The image may have already existed on the user's device. Alternatively, the image may be stored and retrieved from other sources, such as companies like Lemon Wallet that maintain wallets and image collections. In another example, if a user already has an electronic identification document (e.g., electronic passport), the user may not need to input an image of her passport and can instead upload the electronic passport directly into the identification credential agent 120. The electronic document (e.g., passport) can be loaded from the user's device or received from other sources via various technologies (e.g., NFC). A user can also configure and customize the identification credential agent 120 via the user interface 410, subject to any system policy restrictions.

The identification credential agent 120 can communicate with its associated host (e.g., an identification credential client 110) through the host interface 420. In some embodiments, the identification credential agent 120 can receive an image of an identification document (e.g., captured by an image acquisition module 115) through the host interface 420. In some other embodiments, the identification credential agent 120 can receive identification credentials through the host interface 420. For example, if a host device already contains a copy of a user's identification credentials, the identification credentials can be uploaded into the identification credential agent 120 automatically. In some other embodiments, the identification credential agent 120 can obtain device information of the host device via the host interface. For example, the device information can include hardware information of the host device, such as a MAC address of a network interface card, an IMEI number of a smartphone, a serial number of a memory device, a serial number of a CPU, etc. These device information can be used to generate or derive a device ID of the host device.

In some embodiments, the client 110 is not able to extract identification credentials from an image of an identification document. In other embodiments, however, the client 110 is able to do so. If the client 110 is able to extract identification credentials from an image, the identification credential extractor 430 can be used to extract these identification credentials, e.g., from an image of an identification document. In some embodiments, the identification credential extractor 430 can recognize the textual information (e.g., via optical character recognition or OCR techniques) on an image. For example, the identification credential extractor 430 can extract identification credentials (e.g., name, gender, age, and address, etc.) from an image of a user's driver license. If the identification credential extractor 430 is unable to extract sufficient identification credentials, the identification credential extractor 430 can inform the identification credential client/agent 110 and/or request a new image of the identification document or an image of a new identification document, e.g., from the image acquisition module 115.

The device ID determiner 440 can determine a device ID of a user's device (i.e., the identification credential client 110). In some embodiments, the device ID determiner 440 can receive device information (e.g., hardware information) from the host interface 420 and generate a device ID based on the received device information. For example, the device ID determiner 440 can run an algorithm (e.g., a hash function) on the device information to generate a device ID, which can be a globally unique identifier (GUID). A device ID can be used to uniquely identify a device. The device ID of a device can change when one or more components of the device change. The device ID determiner 440 can re-generate the device ID of a device on demand, periodically, or automatically when certain changes are detected.

The identification credential agent 120 of the client 110 can communicate with other components of an identification credential system environment (e.g., 100 in FIG. 1) via the communication module 450. In some embodiments, the identification credential agent 120 of the client 110 can transmit images of identification documents, identification credentials, and/or device ID information to the identification credential server 140, via the communication interface 450. In some other embodiments, the identification credential agent 120 can also transmit other transaction information (e.g., payment information) to the third party 170.

FIG. 5 illustrates an exemplary operation 500 of obtaining and using identification credentials of a user, according to certain embodiments of the disclosed subject matter. The operation 500 can be modified by, for example, having steps rearranged, changed, added, and/or removed. FIG. 5 illustrates, for example, a set of steps that can be formed by the identification credential client 110 or the modules thereof.

At step 510, an image of an identification document of the user can be acquired from a device of the user (i.e., client 110) during a first transaction. An identification document can be any identification card, a driver's license, a passport, a utility bill, or any other document containing identification information (e.g., a biometric passport). In some embodiments, the image can be captured, e.g., by an image acquisition module 115 of an identification credential client 110. In some other embodiments, the image can be received, e.g., via a host interface of an identification credential agent 120. In some other embodiments, the acquired image can be determined (e.g., locally) to be insufficient for extracting identification credentials. In these situations, another image of the identification document or an image of another identification document can be acquired from the device of the user.

At step 520, a device ID of the user's device can be determined. The device ID can be determined based on device information of a device. For example, the device information can include hardware information of a device, such as a MAC address of a network interface card, an IMEI number of a smartphone, a serial number of a memory device, a serial number of a CPU, etc. In some embodiment, the device information of a host device can be retrieved via the host interface of the host device. In some other embodiments, the device ID can be generated by running an algorithm (e.g., a hash function) on the device information. The device ID can be a globally unique identifier (GUID), which can be used to uniquely identify a device. Optionally, 3^{rd} party tools can be used to acquire device IDs. For example, a 3^{rd} party tool can provide a list of the user' other devices from which device IDs can be queried. In some situations, the device ID of a device which is not in the identification credential system environment 100 can be used.

At step 530, the image of the identification document of the user can be transmitted along with the device ID to an identification credential server (e.g., 140 in FIG. 1). The image of the identification document (and/or its extracted identification credentials) can be used to identify the user for the first transaction, e.g., with a third party 170. Alternatively, the image of the identification document can be processed locally before transmission to an identification credential server.

At step 540, during a subsequent transaction the device ID of the device can be transmitted to the identification credential server 140. The device ID determined during the first transaction, for example, can be re-used. The device ID can be used to identify the user for the subsequent transaction, e.g., with the same or a different third party 170. In one embodiment, the first transaction described above can be performed with one third party, such as, for example, an online merchant. Later, during the subsequent transaction, the user may wish to use the same client 110 for a transaction with a different third party. In this case, the different third party may not have the identification credentials of the user. Because the identification credential server 140, however, has the client's 110 device ID and the user's identification credentials from the first transaction, that information can be used to speed up and streamline the subsequent transaction for the user, without requiring the user to enter her identification information a second time.

The operation 500 can have additional steps. For example, a request for transmitting additional identification credentials can be received from an identification credential server. In these situations, the additional identification credentials can be transmitted to the identification credential server. Optionally, the operation 500 can also have a step where a confirmation of identification of the user based on the transmitted device ID during the subsequent transaction is received.

FIG. 6 illustrates another exemplary operation 600 of obtaining and using identification credentials of a user, according to certain embodiments of the disclosed subject matter. The operation 600 can be modified by, for example, having steps rearranged, changed, added, and/or removed. FIG. 6 illustrates, for example, a set of steps that can be formed by the identification credential server 140 or the modules thereof.

At step 610, an image of an identification document of the user can be received during a first transaction, e.g., at an identification credential server 140. An identification document can be any identification card, a driver's license, a passport, a utility bill, or any other document containing identification information. In some embodiments, the image can be obtained using an image acquisition module of a device of the user.

At step 620, a device ID of the user's device can be received, e.g., at the identification credential server. The device ID can be determined based on device information of the user's device as described above.

At step 630, identification credentials of the user can be extracted from the received image, e.g., at the identification credential server 140. In some embodiments, textual information on the image can be recognized as described above, e.g., using optical character recognition or OCR techniques. For example, identification credentials, such as name, gender, age, and address, can be extracted from an image of a user's driver license. If the received image is determined to be insufficient for extracting identification credentials, a request for another image of the identification document or an image of another identification document can be sent, e.g., to an identification credential agent/client.

At step 640, the identification credentials of the user can be authenticated, e.g., with an authentication authority 160. For example, the identification credentials extracted from an image of a driver's license can be authenticated with a governmental authority such as Department of Motor Vehicles. In another example, the identification credentials extracted from an image of a passport can be authenticated with a passport issuing agency. The authentication status can be stored in an identification credential directory (e.g., 300 in FIG. 3).

At step 650, the identification credentials of the user and the device ID of the user's device can be stored, e.g., at the identification credential server 140 or a storage device associated therewith. In some embodiments, the identification credentials can be stored along with the device ID of the user's device from which the identification credentials are originated. For example, an identification credential directory (ICD) can be maintained by an identification credential manager (e.g., 230 in FIG. 2) to store identification credentials and their associated device IDs.

At step 660, during a subsequent transaction the device ID of the user's device can be received, e.g., at the identification credential server 140. The device ID received during the subsequent transaction can be the same as the device ID received during the first transaction.

At step 670, the identification credentials can be retrieved based on the device ID, e.g., at the identification credential server 140. The identification credentials can be previously stored, e.g., in an identification credential directory, on the identification credential server 140 during the first transaction. The identification credentials can be uniquely identified by the device ID.

At step 680, the retrieved identification credentials can be transmitted, e.g., to a third party 170 with which the user desires to transact. The identification credentials can be used to identify the user for the subsequent transaction.

A user can access an identification credential system environment (e.g., 100 in FIG. 1) through various user interfaces. FIG. 7 illustrates an exemplary user interface 700 for obtaining and using identification credentials according to certain embodiments of the disclosed subject matter. As illustrated in FIG. 7, when visiting a merchant/service provider webpage (e.g., using an identification credential agent), a user can simply hit the “Identify Me!” button without entering her identification information (e.g., name, gender, age, and nationality, etc.). If this is the first transaction, the identification credential client 110 can prompt the user for an identification document (e.g., a passport, driver's license, etc.) which can be captured by an image acquisition module 115 of the identification credential client 110. The identification credential client 110 can transmit the captured image of the identification document along with a determined device ID of the host device to an identification credential server 140 to identify the user for the first transaction. During a subsequent transaction, the user can hit the “Identify Me!” button again. This time, the identification credential client 110 can send the device ID of the host device to the identification credential server 140 to identify the user for the subsequent transaction. In this scenario, the user no longer needs to present her identification document to identify herself for the subsequent transaction. The first and subsequent transactions can be directed to the same third party (e.g., vendor or retailer) or different third parties. In addition, the user interface 700 or some variant thereof can be used at third party locations (such as websites) so that the user is easily able to use the “Identify Me!” function to streamline subsequent transactions. In addition, during the first transaction, a user interface can be presented at participating sites (such as websites) that allows the user to easily use the identification system for the first time. For instance, an icon can be presented on a user interface screen at participating sites that lets the user capture her identification information through an image capture device, transmit it to the identification credential server 140, so that this identification information can be used for the first transaction and for subsequent transactions.

Identification credential clients and servers can be implemented in various computing devices. FIG. 8 illustrates a block diagram of a computing system that can be used to implement one or more aspects of the functionality described herein. The computing system 800 can host or serve as, for example, an identification credential client 110, an identification credential server 140, or both in an identification credential system environment (e.g., 100 in FIG. 1). The computing system 800 can include at least one processor 802 and at least one memory 804. The processor 802 can be hardware that is configured to execute computer readable instructions such as software. The processor 802 can be a general processor or be an application specific hardware (e.g., an application specific integrated circuit (ASIC), programmable logic array (PLA), field programmable gate array (FPGA), or any other integrated circuit). The processor 802 can execute computer instructions or computer code to perform desired tasks. The memory 804 can be a transitory or non-transitory computer readable medium, such as flash memory, a magnetic disk drive, an optical drive, a programmable read-only memory (PROM), a read-only memory (ROM), or any other memory or combination of memories.

The computing system 800 can also optionally include a user interface (UI) 806, a file system module 808, and a communication interface 810. The UI 806 can provide an interface for users to interact with the computing system 800 in order to access the identification credential system environment 100. The file system module 808 can be configured to maintain a list of all data files, including both local data files and remote data files, in every folder in a file system. The file system module 808 can be further configured to coordinate with the memory 804 to store and cache files/data. The communication interface 810 can allow the computing system 800 to communicate with external resources (e.g., a network or a remote client/server). The computing system 800 can also include identification credential modules 812. When the computing system 800 hosts or serves as an identification credential client, the identification credential modules 812 can include an image acquisition module (e.g., 115 in FIG. 1) and an identification credential agent (e.g., 120 in FIG. 1). When the computing system 800 hosts or serves as an identification credential server, the identification credential modules 812 can include one or more components of an identification credential server (e.g., 140 in FIG. 2). The description of the identification credential client and server and their functionalities can be found in the discussion of FIGS. 1-7. The computer system 800 can include additional modules, fewer modules, or any other suitable combination of modules that perform any suitable operation or combination of operations.

The identification system described herein can provide a number of benefits to both customers (who use the clients 110) and to merchants or service providers. In addition to the features described above, it can be used to make special offers to users of identification credential clients 110 of the system. For example, accredited users can be offered special pricing or special deals to reflect the knowledge that the customer is known from the identification credential system and is a lower risk for a fraudulent transaction. In another example, the identification system can also recommend products/services to users based on the online activity history of the users (e.g., the websites visited, the product/service purchased, etc.).

It is to be understood that the disclosed subject matter is not limited in its application to the details of construction and to the arrangements of the components set forth in the following description or illustrated in the drawings. The disclosed subject matter is capable of other embodiments and of being practiced and carried out in various ways. Also, it is to be understood that the phraseology and terminology employed herein are for the purpose of description and should not be regarded as limiting.

For example, in additional to the features described above, an identification credential system according to certain embodiment of the disclosed subject matter can also store other transaction related information (e.g., payment information such as credit/debit card information, gift cards, store credits, and discounts, etc.). The stored payment information can be used in conjunction with the identification information to facilitate transactions. In one scenario, once an user's identification credentials are identified, the identification credentials can be sent to a merchant or service provider along with the user's payment information to complete a transaction. The payment information can be stored, for example, on the identification credential server 140 along with identification credentials for the user, and this payment information can be linked to the user through the device ID. Accordingly, when a user desired to use the client 110 for a subsequent transaction, the device ID can be used to retrieve both the payment information (e.g., credit card number, expiration date, and code) along with the identification credentials.

In addition to associating a user's identification credentials with the user via the device ID of the user' device (i.e., something the user has), the user's identification credentials can also be associated with the user via other mechanisms. For example, a user's identification credentials can be linked to something the user knows (e.g., login username/password). In particular, a user's identification credentials can be stored in a user account, e.g., maintained on an identification credential server as described above. A user can access her identification credentials when she logs in to her account, e.g., by entering a username and password pair. Once logged in, the user can view and edit her identification credentials. The user can also utilize her stored identification credentials to conduct transactions with merchants or service provider, e.g., from her user account or from other websites associated with her user account.

As such, those skilled in the art will appreciate that the conception, upon which this disclosure is based, may readily be utilized as a basis for the designing of other structures, methods, and systems for carrying out the several purposes of the disclosed subject matter. It is important, therefore, that the claims be regarded as including such equivalent constructions insofar as they do not depart from the spirit and scope of the disclosed subject matter.

Although the disclosed subject matter has been described and illustrated in the foregoing exemplary embodiments, it is understood that the present disclosure has been made only by way of example, and that numerous changes in the details of implementation of the disclosed subject matter may be made without departing from the spirit and scope of the disclosed subject matter, which is limited only by the claims which follow.

A “server,” “client,” “agent,” “module,” “interface,” and “host” is not software per se and includes at least some tangible, non-transitory hardware that is configured to execute computer readable instructions.

We claim:

1. A computerized method of identifying a user for transactions, comprising:
receiving an image of an identification document of the user during a first transaction with a first party, wherein the image is obtained using an image acquisition module of a device of the user;
receiving a device ID of the user's device;
extracting identification credentials of the user from the image;
storing the identification credentials of the user and the device ID of the user's device on a server, wherein the device ID is associated with the identification credentials of the user;
during a subsequent transaction with a second party, receiving the device ID of the user's device;
retrieving the identification credentials of the user stored on the server based on the device ID received during the subsequent transaction; and
transmitting the retrieved identification credentials to the second party to identify the user for the subsequent transaction.

2. The computerized method of claim 1, wherein the identification document is selected from a group consisting of an identification card, a driver's license, a passport, and a utility bill.

3. The computerized method of claim 1, further comprising authenticating the identification credentials of the user with an authentication authority during the first transaction.

4. The computerized method of claim 1, further comprising:
during the first transaction, determining the received image is insufficient for extracting identification credentials; and
requesting another image of the identification document of the user from the user's device.

5. The computerized method of claim 1, further comprising:
during the first transaction, determining the received image is insufficient for extracting identification credentials; and
requesting an image of another identification document of the user from the user's device.

6. A computer system for identifying a user for transactions, comprising:
a client interface configured to, during a first transaction, receive an image of an identification document of a user from a device of the user and to receive a device ID of the user's device;
an identification credential extractor configured to extract identification credentials of the user from the image;
an identification credential manager configured to, during the first transaction, store both the identification credentials of the user and the device ID, wherein the device ID is associated with the identification credentials of the user; and
a third-party interface configured to, during the first transaction, transmit the identification credentials to a third party to identify the user,
wherein the client interface is further configured to, during a subsequent transaction, receive the device ID, and the identification credential manager is further configured to, during the subsequent transaction, retrieve the identification credentials of the user based on the received device ID,
wherein the third-party interface is further configured to, during the subsequent transaction, transmit the retrieved identification credentials to identify the user.

7. The computer system of claim 6, further comprising an authentication authority interface configured to transmit the identification credentials of the user to an authentication server to authenticate the identification credentials of the user during the first transaction.

8. The computer system of claim 6, wherein the third-party interface is further configured to, during the subsequent transaction, transmit the retrieved identification credentials to the third party to identify the user.

9. The computer system of claim 6, wherein the third-party interface is further configured to, during the subsequent transaction, transmit the retrieved identification credentials to another third party to identify the user.

10. A computerized method of identifying a user for transactions, comprising:
receiving identification credentials of the user during a first transaction with a first party, wherein the identification credentials are obtained using a device of the user;
receiving a device ID of the user's device;
storing the identification credentials of the user and the device ID of the user's device on a server, wherein the device ID is associated with the identification credentials of the user;
during a subsequent transaction with a second party, receiving the device ID of the user's device;
retrieving the identification credentials of the user stored on the server based on the device ID received during the subsequent transaction; and
transmitting the retrieved identification credentials to the second party to identify the user for the subsequent transaction.

11. A computer system for identifying a user for transactions, comprising:
a client interface configured to, during a first transaction with a first party, receive identification credentials of a user from a device of the user and to receive a device ID of the user's device;
an identification credential manager configured to, during the first transaction, store both the identification credentials of the user and the device ID, wherein the device ID is associated with the identification credentials of the user; and
a third-party interface configured to, during the first transaction, transmit the identification credentials to a third party to identify the user,
wherein the client interface is further configured to, during a subsequent transaction with a second party, receive the device ID, and the identification credential manager is further configured to, during the subsequent transaction, retrieve the identification credentials of the user based on the received device ID,
wherein the third-party interface is further configured to, during the subsequent transaction, transmit the retrieved identification credentials to identify the user.

12. A computerized method of identifying a user for transactions, comprising:
during a first transaction with a first party, acquiring an image of an identification document of the user from an image acquisition module of a device of the user;
determining a device ID of the user's device;
transmitting the image of the identification document of the user along with the device ID to a server to identify the user for the first transaction;
during a subsequent transaction with a second party, transmitting the device ID to the server to identify the user for the subsequent transaction; and
receiving confirmation of identification of the user based on the transmitted device ID during the subsequent transaction with the second party.

13. The computerized method of claim 12, wherein the identification document is selected from a group consisting of an identification card, a driver's license, a passport, and a utility bill.

14. The computerized method of claim 12, further comprising:
obtaining device information from the user's device; and
determining the device ID of the user's device based on the device information.

15. The computerized method of claim 14, wherein the device information includes hardware information of the device of the user.

16. The computerized method of claim 14, wherein the determining step includes performing a hash function on the device information to generate the device ID.

17. The computerized method of claim 12, further comprising:
during the first transaction, determining the acquired image is insufficient for extracting identification credentials; and
acquiring another image of the identification document of the user from the user's device.

18. The computerized method of claim 12, further comprising:
during the first transaction, determining the acquired image is insufficient for extracting identification credentials; and
acquiring an image of another identification document of the user from the user's device.

19. The computerized method of claim 12, further comprising receiving a request from the server to transmit additional identification credentials of the user during the first transaction.

20. A device for identifying a user for transactions, comprising:
an image acquisition module configured to capture an image of an identification document of the user;
a device ID determiner configured to determine a device ID of the device; and
a communication module configured to transmit the image along with the device ID to a server to identify the user for a first transaction with a first party, wherein the communication module is further configured, during a subsequent transaction with a second party, to transmit the device ID to the server to identify the user for the subsequent transaction.
